(19) United States
(12) Patent Application Publication
(10) Pub. No.: US 2009/0304017 A1
(43) Pub. Date: Dec. 10, 2009

(54) APPARATUS AND METHOD FOR HIGH-SPEED PACKET ROUTING SYSTEM

(75) Inventors: Seung-Wook Lee, Suwon-si (KR); Joon-Hwan Yi, Seongnam-si (KR); Yong-Ho Song, Seongam-si (KR); Jin-Seok Ha, Hwaseong-si (KR); Seong-Min Jo, Suseong-gu (KR)

Correspondence Address: THE FARRELL LAW FIRM, LLP, 290 Broadhollow Road, Suite 210E, Melville, NY, 11747, US

(73) Assignees: SAMSUNG ELECTRONICS CO., LTD., Suwon-si (KR); IUCF-HYU (Industry-University Cooperation Foundation Hanyang Unversity), Seoul (KR)

(21) Appl. No.: 12/481,406

(22) Filed: Jun. 9, 2009

(30) Foreign Application Priority Data
Jun. 9, 2008 (KR) 10-2008-0053500

(51) Int. Cl. H04L 12/56

(52) U.S. Cl. 370/412

(57) ABSTRACT

An apparatus and method for packet routing in a high-speed packet routing system. The apparatus includes an input unit and a control unit. The input unit temporarily stores an input packet and outputs the temporarily stored input packet to an output port determined by a previous router. The control unit determines an output port of a next router for the input packet.

### PRIORITY

This application claims priority under 35 U.S.C. §119 to an application filed in the Korean Intellectual Property Office on Jun. 9, 2008 and assigned Serial No. 10-2008-0053500, the contents of which are incorporated herein by reference.

### BACKGROUND OF THE INVENTION

1. Field of the Invention

The present invention relates generally to a high-speed packet routing system, and more particularly to a routing apparatus and method capable of packet routing within a single cycle.

2. Description of the Related Art

In general, a router processes an input packet and determines the destination of the packet prior to transmission.

FIG. 1 is a block diagram of a conventional router.

Referring to FIG. 1, the router includes N input units 101 and 103, a control unit 111, and a crossbar 113. The input units 101 and 103 temporarily store packets input through input ports. The control unit 111 generates a control signal for outputting the temporarily stored packets through output ports. The crossbar 113 connects the input ports and the output ports under the control of the control unit 111.

FIGS. 2A to 2C are detailed block diagrams of the conventional router.

Referring to FIG. 2A, when a packet is input through a demultiplexer 201, each of the input units 101 and 103 selects one of First Input First Output (FIFO) buffers 203 and 205, and stores the input packet in the selected FIFO buffer. Also, under the control of the control unit 111, each of the input units 101 and 103 uses a multiplexer 207 to select the one of the FIFO buffers 203 and 205, which is to input a packet into the crossbar 113, and outputs the packet of the determined FIFO buffer to the crossbar 113.

Referring to FIG. 2B, the control unit 111 uses a routing module 221 to determine an output port to which a packet of each of the input units 101 and 103 is to be transmitted. Also, the control unit 111 uses a virtual channel allocator 223 to select a virtual channel (i.e., a FIFO buffer) of the next router in which the packet is to be stored. If the same output port is determined for the packets input through the different input ports, the control unit 111 uses a switch allocator 225 to determine which packet is to be output first.

Referring to FIG. 2C, using the multiplexer 207 connected to all the input ports, and based on the signal received from the switch allocator 225 of the control unit 111, the crossbar 113 connects the corresponding input port and output port to output the corresponding packet.

As described above, the router performs a three-step operation (i.e., routing calculation, virtual channel allocation, and switch allocation) in order to transmit the input packet from the input port to the output port.

FIG. 3 is a flow chart illustrating an operational process of the conventional router.

Referring to FIG. 3, in step 301, the router determines whether a packet is received, i.e., arrived, at the input port. If a packet is received at the input ports, in step 303, the router stores the packet in one of the FIFO buffers using the demultiplexer and performs a routing calculation through the routing module to determine one of the output ports. Herein, the routing calculation for output port determination is performed using a header of the received packet.

In step 305, the router allocates a virtual channel to the determined output port. That is, the router determines one of the FIFO buffers, the stored packet of which is to be transmitted to the determined output port. In step 307, the router allocates a physical channel, i.e., a switch. In step 309, the router transmits the packet through the determined output port.

As described above, the conventional router performs a three-step operation (i.e., routing calculation, virtual channel allocation, and switch allocation) for packet routing. However, due to the high complexity thereof, the virtual channel allocation and the switch allocation are difficult to perform simultaneously. Therefore, each step requires at least one clock cycle. Consequently, the conventional router requires a latency of at least three clock cycles for packet routing, thus degrading the overall router performance.

### SUMMARY OF THE INVENTION

The present invention has been designed to address at least the above problems and/or disadvantages and to provide at least the advantages described below. Accordingly, an aspect of the present invention provides a high-speed routing apparatus and method capable of routing a packet within a single cycle.

Another aspect of the present invention is to provide an apparatus and method for minimizing a latency of routing in a packet routing system.

Another aspect of the present invention is to provide an apparatus and method for a router to predetermine an output port of the next router for a received packet in a packet routing system.

In accordance with an aspect of the present invention, an apparatus for packet routing in a high-speed packet routing system is provided. The apparatus includes an input unit for storing an input packet temporarily and outputting the temporarily stored input packet to an output port determined by the previous router, and a control unit for determining an output port of the next router for the input packet.

In accordance with another aspect of the present invention, a method for packet routing in a high-speed packet routing system is provided. The method includes storing an input packet temporarily, determining an output port of a next router for the input packet, and outputting the input packet and the determined output port information to an output port determined by a previous router.

### BRIEF DESCRIPTION OF THE DRAWINGS

The above and other aspects, features, and advantages of the present invention will become more apparent from the following detailed description when taken in conjunction with the accompanying drawings in which:

FIG. 1 is a block diagram of a conventional router;

FIGS. 2A to 2C are detailed block diagrams of the conventional router;

FIG. 3 is a flow chart illustrating an operational process of the conventional router;

FIG. 4 is a block diagram of a routing system according to an embodiment of the present invention;

FIG. 5 is a block diagram of an input unit in a routing system according to an embodiment of the present invention;

FIG. 6 is a block diagram of a control unit in a routing system according to an embodiment of the present invention;

FIG. 7 is a diagram illustrating structures of a buffer arbitrator and a switch allocator in a routing system according to an embodiment of the present invention;

FIG. 8 is a block diagram of a crossbar in a routing system according to an embodiment of the present invention;

FIG. 9 is a flow chart illustrating a routing process of a routing system according to an embodiment of the present invention; and

FIG. 10 is a graph showing performance of a conventional routing system and the performance of a routing system in accordance with an embodiment of the present invention.

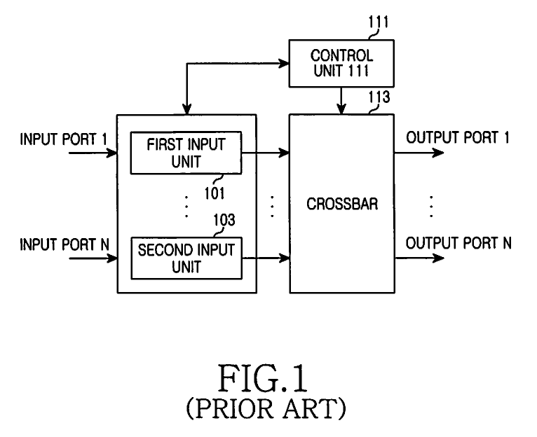

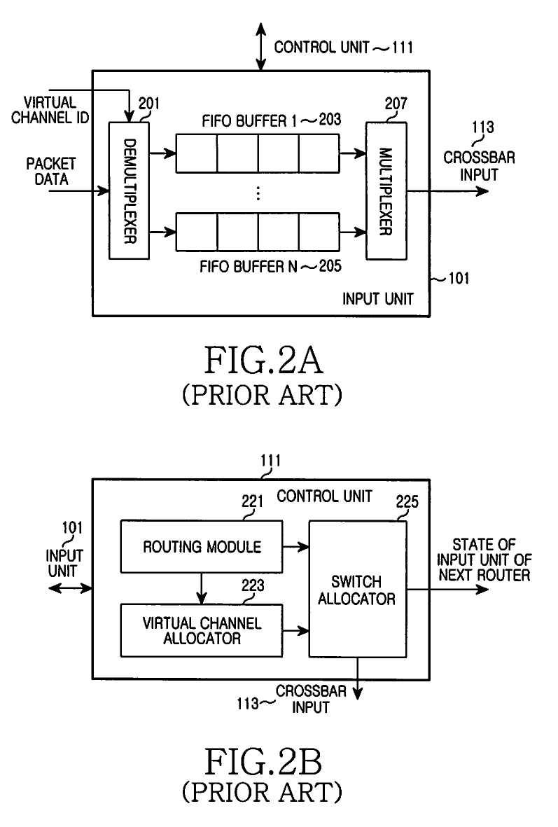

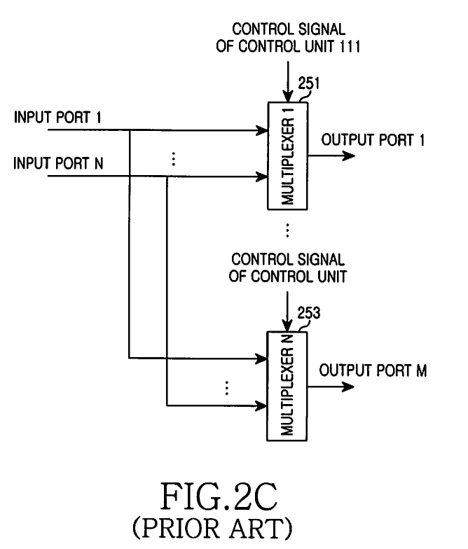

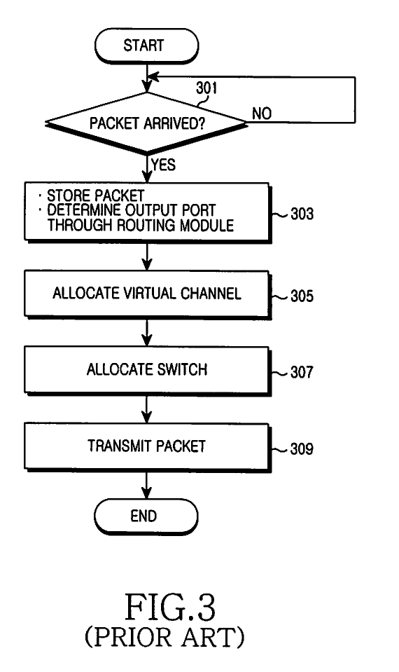

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

As indicated above, a scheme for predetermining an output port of a next router in a packet routing system before a current router stores an input packet in a queue is described herein.

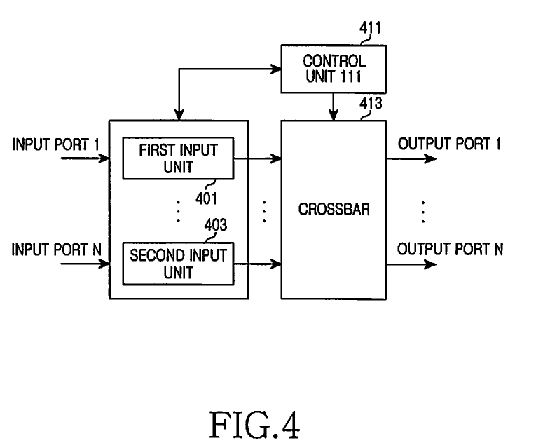

FIG. 4 is a block diagram of a routing system according to an embodiment of the present invention.

Referring to FIG. 4, the routing system includes N input units 401 and 403, a control unit 411, and a crossbar 413. The input units 401 and 403 receive packet data from a previous router, temporarily store the received packet data, and provide the packet data to the crossbar 413. The input units 401 and 403 temporarily store the packet data in a FIFO buffer connected to an output port determined by the previous router, and output the temporarily stored packet data to the output port determined by the previous router.

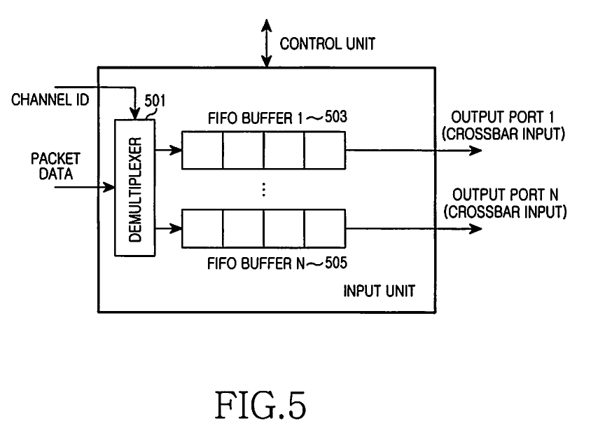

FIG. 5 is a block diagram of an input unit in a routing system according to an embodiment of the present invention.

Referring to FIG. 5, each of the input units 401 and 403 includes a demultiplexer 501 and N First Input First Output (FIFO) buffers 503 and 505.

Using a channel IDentifier (ID) received from the previous router, the demultiplexer 501 determines one of the FIFO buffers 503 and 505 to store the packet data received from the previous router. Herein, the channel ID includes information about the output port of the current router for the packet data, which is determined by the previous router. The demultiplexer 501 selects one of the FIFO buffers 503 and 505 to store the packet data as indicated by the channel ID.

Each of the FIFO buffers 503 and 505 temporarily stores packet data received from the demultiplexer 501 and outputs the temporarily stored packet data to a specific output port. Each of the FIFO buffers 503 and 505 is connected to a specific output port, such that the packet data output from the FIFO buffer 503 and 505 are provided to a switch of the crossbar 413 directly, not through a multiplexer.

The control unit 411 controls the output of the packet data temporarily stored in each of the input units 401 and 403. The control unit 411 determines an output port of a next router for the packet data temporarily stored in the input units 401 and 403, and controls the temporarily stored packet data to be output through the crossbar 413 to the corresponding output port.

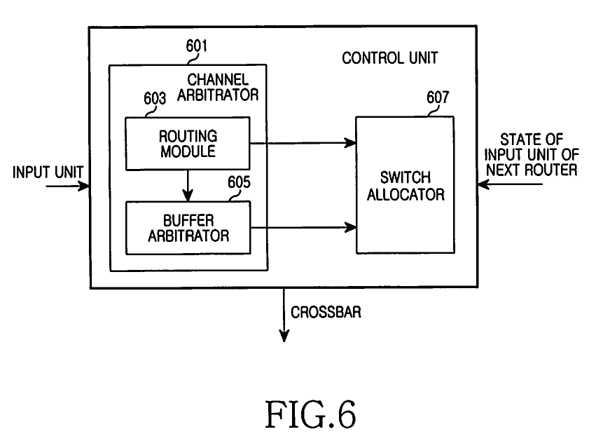

FIG. 6 is a block diagram of a control unit in a routing system according to an embodiment of the present invention.

Referring to FIG. 6, the control unit 411 includes a channel allocator 601 and a switch allocator 607. The channel allocator 601 includes a routing module 603 and a buffer arbitrator 605. The channel allocator 601 uses the routing module 603 to determine an output port of the next router for each packet data, and uses the buffer arbitrator 605 to prevent input packet data of different input ports from being inputted into the same FIFO of the next router. The channel allocator 601 outputs information about the determined output port of the next router to the crossbar 413, such that the output port information is provided to the next router together with the corresponding packet data. Hereinafter, the determined output port of the next router is also referred to as a channel ID.

The routing module 603 determines an output port of the next router that will be used to output the packet data of the current router. This differs from the conventional art in that the routing module 221 determines an output port of the current router. The routing module 603 determines an output port of the next router, such that the packet data input into the FIFO buffers 503 and 505 of the input units 401 and 403 are always output through the output port determined by the previous router. That is, an output port for a packet stored in the current router is predetermined by the previous router, and the current router determines an output port of the next router. When the current router predetermines an output port of the next router, the input unit of the next router may determine one of the FIFO buffers to store input packet data.

If the input packets of different input ports are to be input into the same FIFO buffer of the next router, the buffer arbitrator 605 arbitrates the input of the input packets. That is, if the same output port of the next router is determined for the input packets of different input ports according to the routing operation of the routing module 603, the buffer arbitrator 605 prevents the input packets of the different input ports from being inputted into the same FIFO buffer of the next router at the same time. This may be solved by differentiating the times of outputting the input packets of the different input ports to the next router, or by changing the output ports for the input packets of other input ports than a specific input port.

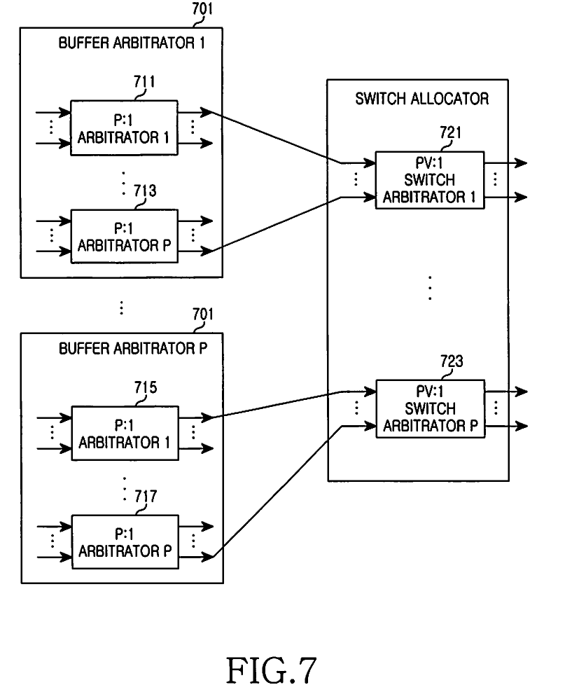

FIG. 7 is a diagram illustrating structures of a buffer arbitrator and a switch allocator in a routing system according to an embodiment of the present invention.

Referring to FIG. 7, unlike the virtual channel allocator 223 of the conventional router, the buffer arbitrator 605 performs a buffer allocation operation in a single step. In this case, the buffer arbitrator 605 has a complexity of p³, where p denotes the number of input ports.

As in the conventional router, the switch allocator 607 arbitrates a crossbar use request in order to transmit the packet data of each input port to the corresponding output port. That is, the switch allocator 607 generates a signal for requesting to connect the output of each of the FIFO buffers 503 and 505 to a specific output port, and provides the generated signal to the crossbar 413.

As illustrated in FIG. 7, the switch allocator 607 uses one switch arbitrator 721/723 per output port. Because each of the FIFO buffers 503 and 505 is connected to one output port, the present invention may perform a switch arbitration operation in a single step, unlike the conventional router. In this case, the switch allocator 607 has a complexity of p²v, where p denotes the number of input ports, and v denotes the number of virtual channels, i.e., the number of the FIFO buffers.

The crossbar 413 connects the output of each of the FIFO buffers 503 and 505 to a specific output port.

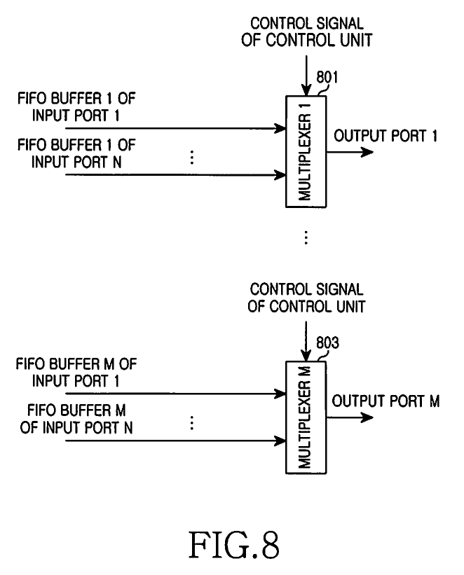

FIG. 8 is a block diagram of a crossbar in a routing system according to an embodiment of the present invention. As illustrated in FIG. 8, the crossbar 413 includes a plurality of multiplexers 801 and 803. That is, unlike the conventional crossbar 113, the crossbar 413 does not share the outputs of all the input ports at each multiplexer, and uses the output from one determined FIFO buffer because the packet input into each FIFO buffer is transmitted to one predetermined output port. At this point, the crossbar 413 receives a channel ID of the corresponding packet data, i.e., the output information of the next router for the corresponding packet data, from the control unit 411, and provides the channel ID and the corresponding packet data to the next router.

If the number of the input/output ports is 5 and the number of the FIFO buffers of each input unit is 5, the conventional router requires 60 arbitrators, whereas an embodiment of the present invention uses 30 arbitrators for virtual channel allocation and switch allocation.

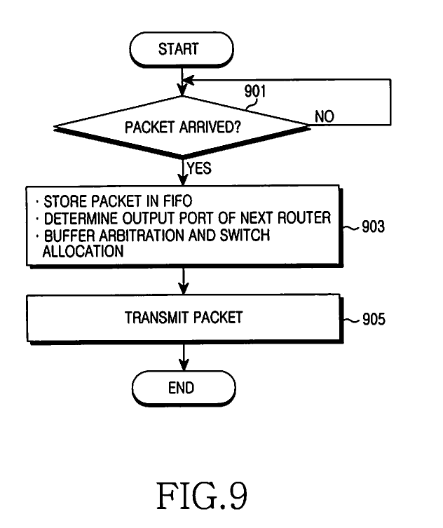

FIG. 9 is a flow chart illustrating a routing process of a routing system according to an embodiment of the present invention.

Referring to FIG. 9, in step 901, the routing system determines whether a packet output from the previous router is received, i.e., arrives, at an input port. If the packet is received at the input port, in step 903, the routing system sets the multiplexer on the basis of the channel ID received from the previous router, for storing the received packet in the desired FIFO buffer. That is, the routing system sets the multiplexer corresponding to the output port indicated by the channel ID, for storing the packet in the FIFO buffer connected to the output port. Also, in step 903, the routing system determines an output port of the next router for the received packet, and performs buffer arbitration and switch allocation.

In step 905, the routing system transmits the packet through the corresponding output port. Thereafter, the routing system ends the routing process.

In the above description, the packet storage, next router output port determination, buffer arbitration, and switch allocation operations are performed in parallel, i.e., in a same step. The reason for this is that the complexity of the control unit 411 is similar to that of the virtual channel allocator 223 in complexity in the conventional router. That is, because the overall complexity of the control unit 411 in the routing system is equal to the complexity of the virtual channel allocator 223 in the conventional router, the present invention may perform the above operations in a single step.

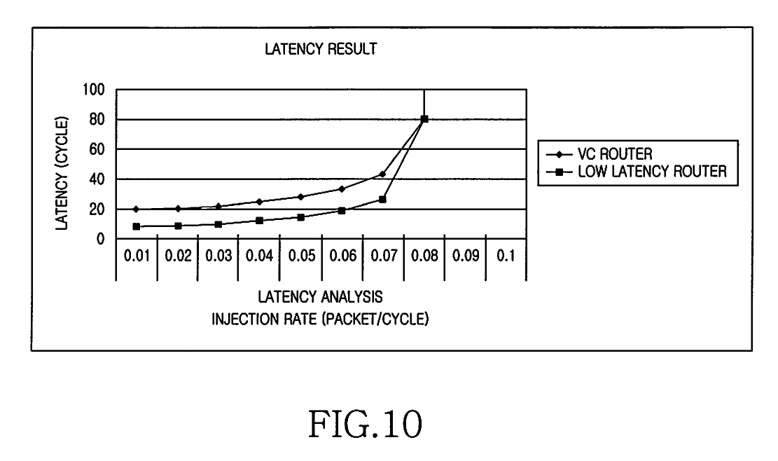

FIG. 10 is a graph showing a performance of a conventional routing system and a performance of a routing system in accordance with an embodiment of the present invention. Herein, the x-axis represents the amount of packets input into a network, and the y-axis represents a processing latency.

The graph of FIG. 10 shows the processing latency of a conventional routing system (VC Router) and the processing latency of the present invention routing system (Low Latency Router). As shown in FIG. 10, a routing system in accordance with an embodiment of the present invention has a lower latency than the conventional routing system, if the amount of packets input into the network is smaller than or equal to a certain amount. The reason for this is that the present invention reduces the complexity of the control unit and implement a single-step control operation by connecting each FIFO buffer to a specific output port and predetermining an output port at the previous router.

As described above, a packet routing system in accordance with embodiment of the present invention predetermines an output port of the next router for each packet and outputs a packet, which was input into one virtual channel queue, to an output port connected to the corresponding virtual channel queue, thereby making it possible to simplify the logic for virtual channel allocation and physical channel allocation, minimize the latency of routing, and implement a high-performance communication backbone environment in a multi-computing environment. Also, in accordance with embodiments of the present invention, it is possible to develop a system-on-chip using an on-chip router structure.

While the present invention has been shown and described with reference to certain embodiments thereof, it will be understood by those skilled in the art that various changes in form and details may be made therein without departing from the spirit and scope of the invention as defined by the appended claims. Therefore, the scope of the invention is defined not by the detailed description of the invention, but by the appended claims and their equivalents.

What is claimed is:

1. An apparatus for packet routing in a high-speed packet routing system, comprising:
an input unit for temporarily storing an input packet and outputting the temporarily stored input packet to an output port determined by a previous router; and
a control unit for determining an output port of a next router for the input packet.

2. The apparatus of claim 1, wherein the input unit comprises:
a plurality of First Input First Output (FIFO) buffers for storing temporarily the input packet and outputting the temporarily stored packet to a specific output port; and
a demultiplexer receiving a packet and output port information from the previous router and outputting the received packet to one of the plurality of FIFO buffers connected to the output port.

3. The apparatus of claim 2, further comprising a crossbar for connecting an output of each of the plurality of FIFO buffers to a specific output port.

4. The apparatus of claim 1, wherein the controller comprises:
a routing module for determining the output port of the next router for the input packet;
a buffer arbitrator for preventing input packets of different input ports from being output to a same output port of the next router; and
a switch allocator for controlling a connection between the input port and the output port.

5. The apparatus of claim 1, wherein temporarily storing the input packet and determining the output port of the next router for the input packet are performed simultaneously.

6. A method for packet routing in a high-speed packet routing system, comprising:
temporarily storing, by an input unit, an input packet;
determining, by the input unit, an output port of a next router for the input packet; and
outputting, by the input unit, the input packet and the determined output port information to an output port determined by a previous router.

7. The method of claim 6, wherein temporarily storing the input packet comprises:
receiving a packet and output port information from the previous router;
outputting the packet to one of First Input First Output (FIFO) buffers connected to the output port; and
temporarily storing the packet in one of the FIFO buffers that is connected to the output port.

8. The method of claim 7, wherein an output of each of the FIFO buffers is connected through a crossbar to a specific output port.

9. The method of claim 6, wherein outputting the input packet and the determined output port information to the output port determined by the previous router comprises:
detecting whether input packets of different input ports are output to a same output port of the next router; and
preventing the input packets of the different input ports from being output to the same output port of the next router.

10. The method of claim 6, wherein temporarily storing the input packet and determining the output port of the next router for the input packet are performed simultaneously.
